(19) United States
(12) Patent Application Publication
(10) Pub. No.: US 2007/0121166 A1
(43) Pub. Date: May 31, 2007

(54) Process for multi-layer material removal of a three-dimensional surface by using a raster image describing the surface

(76) Inventor: Raul Hess, Hordt (DE)

Correspondence Address: HENRY M FEIEREISEN, LLC, 350 FIFTH AVENUE, SUITE 4714, NEW YORK, NY, 10118, US

(21) Appl. No.: 10/572,757

(22) PCT Filed: Sep. 24, 2004
(86) PCT No.: PCT/EP04/10761

§ 371 Date: Mar. 20, 2006

(30) Foreign Application Priority Data
Sep. 26, 2003 (DE) 10345087.4

(51) Int. Cl. G06K 15/00

(52) U.S. Cl. 358/3.03

(57) ABSTRACT

The application refers to a method for a layer by layer material removal from an arbitrarily shaped three-dimensional surface (1) by removal means, such as a laser, operating on the surface in a point-wise fashion, wherein the removal means is used to produce a surface structure (2) on the three-dimensional surface (1) and can be carried out by mapping the surface (1) on planar layers, whereby the surface structure is represented by raster images (3). These raster images (3a) include gray levels (5). The gray levels (5) correspond to the depth of the surface structure.

To date, etching processes or galvanic processes have been used to remove material of a three-dimensional surface layer-by-layer, for example for producing a mold with an arbitrarily shaped surface structure. A positive model with the desired surface shape was covered with a metal, which was used as a negative mold for producing a component or foil with the desired shaped. These process variants always require a large number of process steps, before a negative mold for only a single surface structure is obtained. As a result, every change in the surface structure requires that the same process steps be repeated.

Two processes are currently used for economically producing tools that generate a three-dimensional surface of arbitrary shape. This is, on one hand, the etched grain whereby the surface of the workpiece is masked to a different degree and then selectively removed in an etching solution. In a limited way, this process can also be used to remove material layer-by-layer. However, this process disadvantageously produces a stepped transition between grain peaks and grain valleys. Additional difficulties arise with complex geometries of the surface to be embossed.

Another process is the galvano process. In this case, a positive model, the so-called model to be lined with leather, is covered with a foil (or leather), which has the desired grain. The grain is transferred in a duplicate molding process to a negative tool, which is then used to produce a (positive) electroplating model. A metal layer is then applied galvanically in an electrolyte bath. The resulting galvano tool still has to be reinforced, and can therefore only be used in certain processes for the manufacture of parts that do not overly stress its surface. Commonly used are the slush process and the spray skin process. However, the latter processes are both time-consuming and costly.

Due to the complexity of conventional processes, in particular when used on an industrial scale, attempts have been made to produce the surface structure with a removal means. One frequently used removal means is a laser. DE 3939866 A1 discloses a technology for removing material with a laser, as applied to laser engraving.

Material removal by evaporating a surface layer with a laser is disclosed in DE 4209933 C2. The laser beam is expanded and steered by rotating deflection mirrors along a reference line defined by a computer. The reference lines form a raster field. The laser beam scans the raster field several times along reference lines which are offset relative to each other at an angle, whereby material is removed through evaporation. The systematic appearance of raised portions in the boundary layer is eliminated by varying the direction of the laser tracks by a certain angle through rotation in the machining plane. This produces a grid-like structure of the raster lines. This technology is exclusively applied to two-dimensional surfaces, i.e., planar components. The technology described in the aforementioned patent attempts to uniformly remove material in the raster field.

Steering the laser line-by-line along paths (raster lines), or tracks, in the respective machining field of the laser is disclosed in DE 1003298 A1. The tracks are applied in certain areas of a moving workpiece. To prevent the formation of a sharp boundary line in the overlap area of the tracks at the boundaries of the regions, which is produced by excessive material removal in the overlap area, the boundaries of the regions are offset at each removal step. Stated differently, during the line-wise removal of an area, the laser is incident not along a line on the edge, but rather moves only close to this line. The endpoint of the material removal is then moved back from this line, with the spacing differing from line to line. No optical defect is perceived, because the endpoints are statistically distributed about the mean value of the line. This process is suitable for removing material in raster fields arranged on the same plane. However, if the raster fields are inclined with respect to each other, then the removal means removes a different quantity of material when the removal means moves out of the raster field. Accordingly, each endpoint determining the material removal would have to be recorded, and the material removal for the adjacent raster field would have to be corrected to account for the shortfall. For this reason, application of this process with three-dimensional surfaces would require substantial additional computing power. The two U.S. Pat. Nos. 6,300,565 B1 and 6,407,361 B1 disclose a layer-by-layer removal of material for producing three-dimensional structures in planar surfaces. Each time a layer is machined, the material is removed in all machining fields in a form which represents a rotationally symmetric recess in a planar surface.

According to the technical teaching of DE 10116672 A1, coarse and fine structures are machined differently, whereby fine regions are machined with a laser and coarse regions are machined with a stripping device. This technology is particularly suitable for machining metal surfaces that are arranged, for example, on printing drums. The coarse machining is performed with mechanical material removal devices.

The present state-of-the-art is limited to machining planar or cylindrical surfaces. No process exists today that is capable of introducing a surface structure in a three-dimensional surface of arbitrary shape.

It is an object of the invention to apply a surface structure, such as a grain, to an arbitrary three-dimensional surface. The object is solved by the process of the invention, which makes it possible to apply a three-dimensional surface structure to tools and models of arbitrary shape. Such surface structure is, for example, the grain of leather, which is characterized in that the peaks of the grain have different heights and extensions and that the transition between grain peaks and grain valleys is smooth.

It is another object of the invention to prevent dividing lines or boundary lines during the material removal. To accomplish this, conventional processes would have to be modified so that the removal means operates not in a two-dimensional coordinate system or a cylindrical coordinate system, but rather in an arbitrary three-dimensional coordinate system.

It is another object of the invention to use the process with different types of materials or material combinations. As compared to a conventional process, the process of the invention should also be faster and should have no restrictions as to the surface structure to be mapped.

These objects of the invention are implemented by the following processes for removing single layers or multiple layers of material from a three-dimensional surface of arbitrary shape by a removal means operating on a point of a surface, such as a laser.

The process for removing single layers or multiple layers of material from a three-dimensional surface of arbitrary shape by a removal means which operates in a point-wise fashion on a surface, such as a removal means operating with a laser, wherein a surface structure is generated on the three-dimensional surface, is characterized in that at least one raster image is associated with the surface. The raster image represents a two-dimensional map of the three-dimensional surface. The raster image includes a plurality of pixels. A gray level is associated with each pixel, wherein the gray level is a measure for the depth of the surface structure. If material is to be removed without exhibiting visible steps, then two adjacent gray levels can advantageously correspond to a height difference of no more than 10 μm. Accordingly, a quantity of material to be removed is associated with each gray level. An identical quantity of material is removed for each pixel having the same gray level. If several gray levels exist, then the quantity of material is removed in layers. Each gray level corresponds to a single layer, which is removed, for example, with a laser.

Each layer is transformed into an intersecting surface of the three-dimensional surface, wherein the intersecting surface is described by a mathematical function. This mathematical function is the basis for controlling a removal means in a three-dimensional coordinate system. An intersecting surface refers to a curved surface which is parallel to the surface to which the surface structure is to be applied. Because the intersecting surface intersects the texture or surface structure, this plane will be referred to hereinafter as intersection. In the simplest case, namely a planar surface, this is the section plane. The intersection is covered with a network of polygons. The removal means, for example the laser, removes material inside a polygon, if the polygon is associated with a gray level. Each polygons of the intersection is covered with machining surfaces, wherein the machining surface is completely enclosed in the machining area of the removal means. If the removal means is a laser, then a machining area corresponds to the focal depth of the laser device and includes at least a polygon of the intersection. Material is removed line-by-line inside the machining surface along the gray levels. The polygons of intersections are advantageously offset relative to one another or rotated with respect to one another. In another embodiment, the polygons of adjacent intersections can be randomly arranged, so as to ensure that polygons of two adjacent intersections do not have common edges.

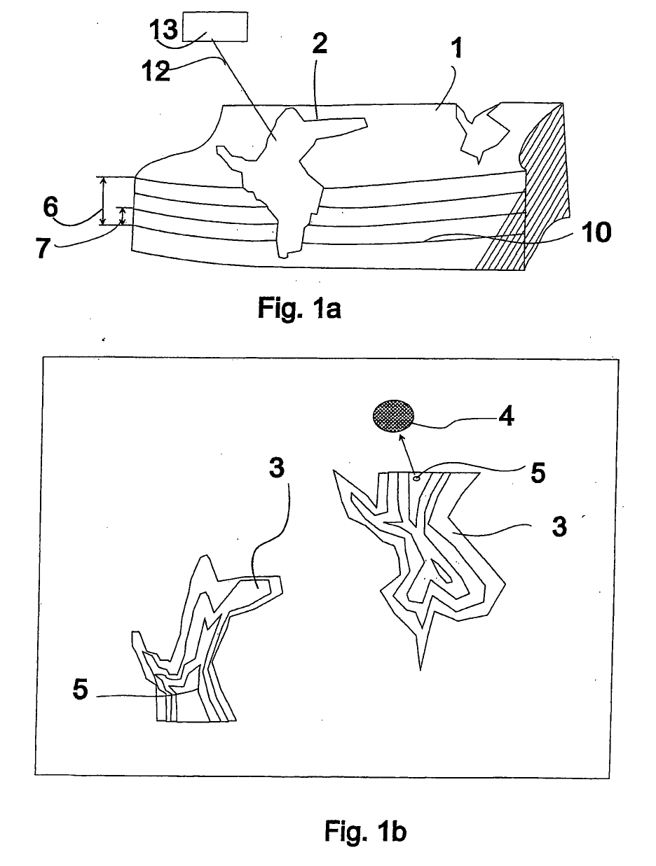

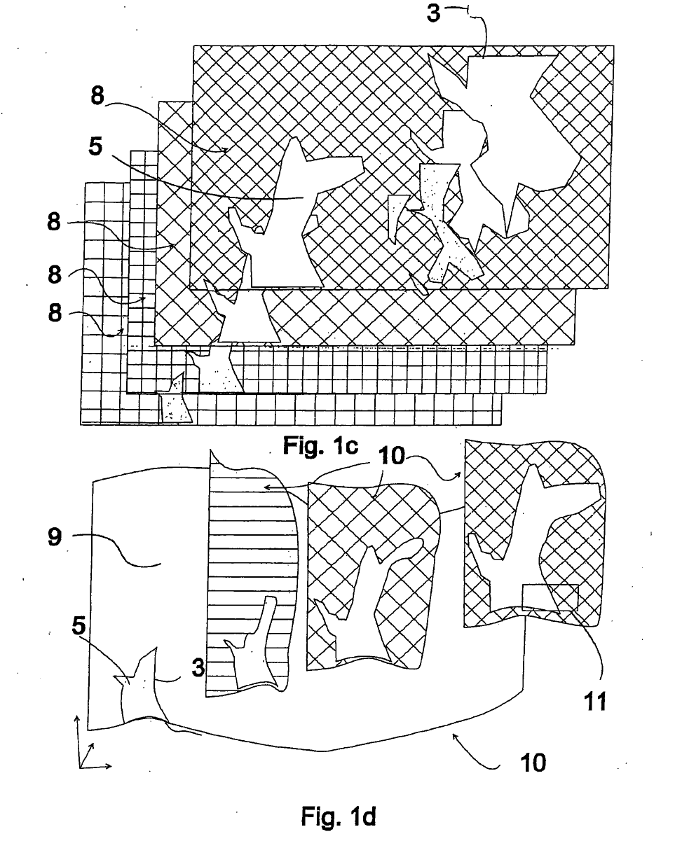

FIG. 1a shows schematically a three-dimensional surface with a surface structure;

FIG. 1b shows schematically a first step of the process;

FIG. 1c shows schematically a second step of the process; and

FIG. 1d shows schematically a third step of the process.

The process for selectively removing material layer-by-layer from a workpiece is used to introduce in the workpiece, which is depicted in FIG. 1a as a three-dimensional surface 1, a structure, for example in form of a grain. The surface 1 is characterized in that the transitions between grain peaks and grain valleys are as smooth as possible. Arbitrary surface structures or grains must be described in a form that can be produced by a conventional process for removing material, in particular a laser process. The description of the topology, i.e., the geometry of the workpiece, is here distinct from the description of the surface structure, for example the grain, i.e., from the desired fine structure of the surface, which is produced with the tool by a shaping process.

To perform the process for removing a single layer or multiple layers of material from a three-dimensional surface of arbitrary shape with a removal means operating on a point of the surface, a surface structure 2 located on the three-dimensional surface 1 is projected onto a two-dimensional surface. At least one raster image 3 is associated with the two-dimensional surface. The raster image 3 represents a two-dimensional map of the three-dimensional surface structure 2 and is schematically illustrated in the example depicted in FIG. 1b. The two surface structures 2 in FIG. 1a are therefore described by two adjoining raster images 3. A cross-section through the three-dimensional surface structure parallel to the surface 1 generates an intersection 10 which is projected on to a two-dimensional surface. A gray level 5 is associated with this cross-section. The contours of the gray levels 5 on the raster images 3 correspond to the contour lines in the surface structure 2. This process is capable of photographically mapping an arbitrary surface structure. Graphic processing means can then associate a gray level 5 with each layer 8. Conversely, the gray levels 5 resulting from the photographic image can be uniquely associated with a layer 8. The raster image 3 and the two-dimensional surface include a number of pixels 4 to serve as a means for graphic processing. A gray level 5 is associated with each pixel 4, wherein the gray level 5 is a measure for the depth 6 of the surface structure.

In order to remove material without visible steps, two adjacent gray levels 5 on two layers 8, which form two intersections 10 in three-dimensional space, should have a height difference of no more than 10 μm. In this way, the quantity of material to be removed is defined for each gray level 5.

The gray levels can in principle have an arbitrary gradation, with a maximum of 256 gray levels. If it were desirable to vary the accuracy of the machining process as a function of the depth, then the difference between the gray levels and hence the spacing between the layers 8 can be adjusted. The same quantity of material is removed for each pixel 4 having the same gray level 5. If several gray levels 5 exist, then the quantity of material is removed in several machining steps. Each gray level corresponds to a layer which is removed by a removing means, such as for example a laser 12. The wider the layer, the greater the volume to be removed. When using a laser 12, the width of the layer is only limited by the width of the volume in focus, which will be described below. A layer 8 of this type is machined by covering the intersection 10 associated with a layer with a plurality of adjoining polygons 9. The laser removes material inside a polygon 9, if the polygon 9 is associated with a gray level 5. The polygons 9 on the intersection 10 can be described by a mathematical function. This mathematical function forms the basis for controlling the removing means in a three-dimensional coordinate system.

Each intersection 10 is subsequently covered with machining planes 11. A machining plane of this type is depicted in FIG. 1d. The machining plane 11 includes the machining area of the removal means, wherein the removal means is preferably a laser device. In principle, different removal means can also be employed in combination. These polygons 9 must be divided into machining surfaces 11 for machining with the laser. A machining surface of this type is illustrated in FIG. 1d. Because the intersection 10 can be at least approximately described as a mathematical function by the polygons 9, the machining planes 11 can be computed from this function if the optical properties of the laser device are known. The size of the machining surface 11 is ideally selected so that it can be scanned by controlling only the galvano mirror when the scanner is in a suitable position. Advantageously, the scanner position is located approximately perpendicular to the machining surface 11. Any change in the distance between the scanner and the machining surface 11 should also be kept as small as possible. The size of the machining surface 11 should be selected so that the quantity of the removed material is affected neither by the angular orientation of the laser nor by changes in the spacing between the machining surface and the scanner.

Each machining surface 11 should be located entirely within the focal range of the laser. The machining surface 11 forms a part of the machining area. The possible machining range in a defined position of the scanner can be described by the focal volume when using a flat field lens. If the maximal failure of the removed layer thickness is predefined, then the height of the focal volume is given by the maximal depth of focus (=deviation from the focal length) and its lateral extent caused by the corresponding maximum deflection of the galvano mirror in the scanner. The distance between the scanner and the center plane of the focal volume is defined by the focal length of the laser optics. Inside the focal volume, the machining surface 11 can be approximated by at least one polygon 9 having corners, all of which are located on an intersection 10, which is spaced from the laser optics by exactly one focal length and is located perpendicular to the direction of the laser beam at the center position of the deflection mirror. The machining surface 11 hence matches the focal depth of the laser device and includes at least one polygon 9. The material is removed line-by-line inside the machining surface 11 along the gray levels 5, so that the polygon includes gray levels 5. No material is removed in polygons without gray levels 5.

In order to prevent dividing lines which are generated in an area where one laser track terminates and the next laser track begins, the layer thickness is reduced to a degree, so that the height of the resulting boundary line is negligible compared to the total height of the surface structure, such as a leather grain. A dedicated independent three-dimensional polygon network is associated with each intersection 10 where material is to be removed to prevent that the failure from the dividing line at the polygon edges is added in. The polygon network can be selected in any manner by taking into consideration the aforementioned requirements. Polygon edges of adjacent intersecting surfaces 10 are allowed to overlap, but must not lie on top of one another. Otherwise, the failure along the dividing line is would be added. Stated differently, when considering an arbitrary point on the intersection of the workpiece to be processed and a removal of material in n layers, this point may “belong” to n different polygons. In advantageous embodiments, the polygons 9 of each intersection 10 are offset or rotated relative to one another. In another embodiment, the polygons 9 of each intersecting plane can be arranged randomly, under the condition that the polygons 9 of two adjacent intersecting surfaces 10 do not have common edges. The workpiece is processed with a laser device 13, whereby a scanner, which includes the galvano mirrors, has sufficient agility relative to the workpiece so as to reach a position which is preferably perpendicular in relation to each polygon and located at the focal distance of the laser optics, i.e., the position of the scanner corresponds to the position forming the base for the computation of the polygons.

For machining economically, the laser device should be controlled by arranging the polygons in the dataset such that they are read by the control electronics in an order which requires the least travel by the scanner.

### REFERENCE NUMERALS

1 surface
2 surface structure
3 raster image
4 pixel
5 gray level
6 depth
7 height difference
8 layer
9 polygon
10 intersection
11 machining surface
12 laser
13 laser device

1-13. (canceled)

14. A process for removing material from a non-planar three-dimensional surface having an arbitrary shape, comprising the steps of:
associating a desired surface structure on a three-dimensional surface to at least one raster image which describes the surface structure; and
producing the surface structure on the three-dimensional surface through point-wise removal by a removal tool to thereby remove material layer-by-layer in correspondence to the raster image.

15. The process of claim 14, wherein the removal tool is a laser.

16. The process of claim 14, wherein the raster image comprises a two-dimensional map of the three-dimensional surface.

17. The process of claim 14, wherein the raster image comprises a plurality of pixels.

18. The process of claim 17, wherein a gray level is associated with a pixel.

19. The process of claim 18, wherein the gray level associated with a pixel represents a depth of the surface structure, as measured from the non-planar three-dimensional surface.

20. The process of claim 18, wherein the gray level associated with a pixel represents a depth of the material removed from the surface.

21. The process of claim 18, wherein identical gray levels of the pixels indicate removal of a substantially identical quantity of material for each of the pixels having the identical gray level.

22. The process of claim 18, wherein pixels having identical gray levels are associated with the same layer in the multi-layer removal process.

23. The process of claim 22, wherein each layer is described by a plurality of adjoining polygons, said polygons describing the three-dimensional surface as a mathematical function.

24. The process of claim 23, and further comprising controlling the removal tool in a three-dimensional coordinate system based on the mathematical function.

25. The process of claim 23, wherein the removal tool removes material inside a polygon, when the polygon is associated with a gray level.

26. The process of claim 25, wherein the removal tool removes the material inside the polygon by scanning the removal tool line-by-line across the polygon, said scan inside the polygon defining at least one machining surface.

27. The process of claim 23, wherein the polygons of two superpositioned layers in the multi-layer removal process are placed so as not to have common edges by at least one of offsetting the polygons relative to one another, rotating the polygons with respect to one another, randomly arranging the polygons, or providing the polygons with different sizes.
